(19) United States
(12) Patent Application Publication
(10) Pub. No.: US 2004/0016155 A1
(43) Pub. Date: Jan. 29, 2004

(54) Memos having a solid advertising effect

(76) Inventor: Po-Lu Tsai, Tainan City (TW)

Correspondence Address: Po-Lu Tsai, P.O. Box 6-9, Tainan, TW

(21) Appl. No.: 10/320,116

(22) Filed: Dec. 12, 2002

(30) Foreign Application Priority Data
Jul. 29, 2002 (TW) 91211946

(51) Int. Cl. G09F 1/00

(52) U.S. Cl. 40/124.191

(57) ABSTRACT

Memos having a solid advertising effect include an upper and a lower cover and a plurality of memos packed between the upper and the lower cover. The upper cover and the memos respectively have printed advertising characters or designs, their rear ends glued together, and their front ends forming a sloped corrugated surface printed on with advertising characters or designs of coordinate colors with those of the upper cover. The upper cover and the memos combined together form solid beauty, having an esthetic appearance, extensive practicability and an excellent advertising effect.

### BACKGROUND OF THE INVENTION

This invention relates to memos having a solid advertising effect, particularly to one having an upper and a lower cover and note packing a plurality of memos respectively printed with advertising characters or designs printed on a sloped surface formed by front ends of the covers and the memos and cut to form a solid corrugated slope, able to maintain integral beauty of a pack of memos with an excellent advertising effect.

Conventional memos (A) are formed by numerous sheets of memos together and orderly arranged tidily, with one end glued together and packed between an upper cover and a lower cover. To beautify appearance and increase advertising effect, some conventional memos are printed thereon with designs of different colors, and others have a thick cover printed with advertising characters, as shown in FIG. 1, and still others are placed in a cardboard box (B) which is printed with a variety of designs or advertising characters on the upper cover, as shown in FIG. 2. Another conventional memos disclosed in a Taiwan Publication No. 334936, titled “NOTE PAPER” (C), as shown in FIG. 3, are provided with a cover without designs printed thereon, spoiling its integral beauty, and its front sloped surface is flat, unable to attract a user.

### SUMMARY OF THE INVENTION

The objective of the invention is to offer memos having an upper thick cover and a lower thick cover packing a plurality of memos. A pack of memos forms front surface cut to form a solid corrugated slope having advertising characters or designs printed thereon, having an esthetic appearance and achieving an excellent advertising result.

The feature of the invention is that the memos with an upper thick cover and a lower thick cover have rear ends adhered together, and their front ends forming a sloped surface printed on with advertising characters or designs and cut into a solid corrugated slope from top to the bottom, having a bulging configuration for advertising.

### BRIEF DESCRIPTION OF DRAWINGS

This invention will be better understood by referring to the accompanying drawings, wherein:

FIG. 1 is a perspective view of first conventional memos:

FIG. 2 is a perspective view of second conventional memos:

FIG. 3 is a perspective view of a third conventional memos disclosed in a Taiwan Publication No. 334936:

FIG. 4 is a perspective view of memos with a solid advertising effect in the present invention:

FIG. 5 is a perspective view of the memos in a using condition in the present invention: and

FIG. 6 is a side cross-sectional view of the memos in the present invention.

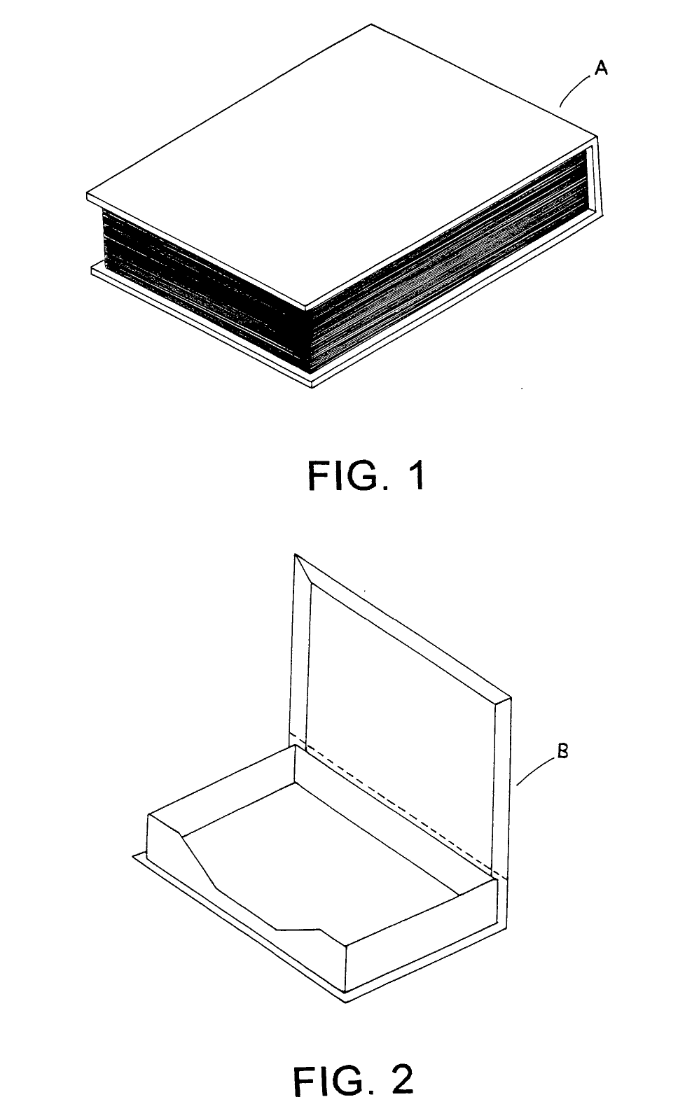

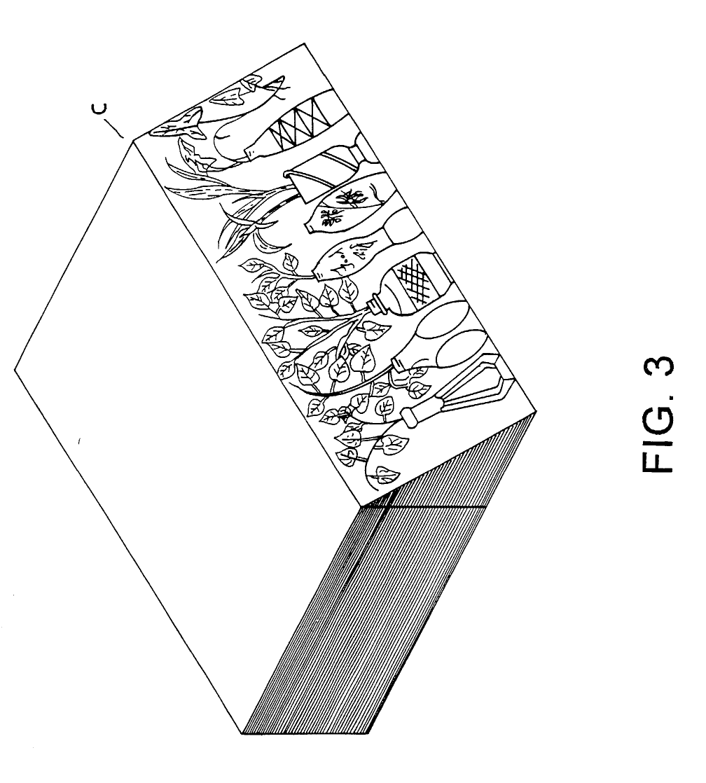

### DETAILED DESCRIPTION OF THE PREFERRED EMBODIMENT

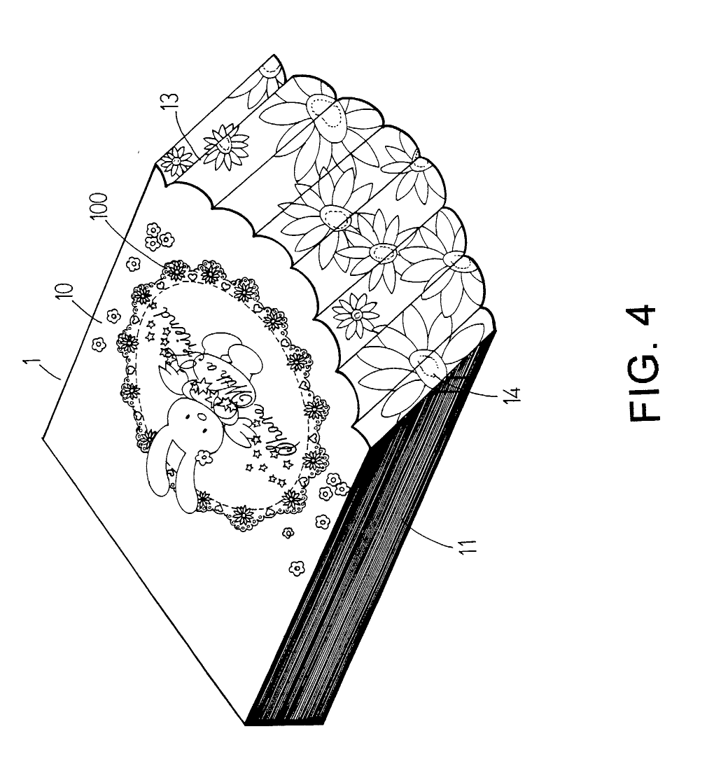

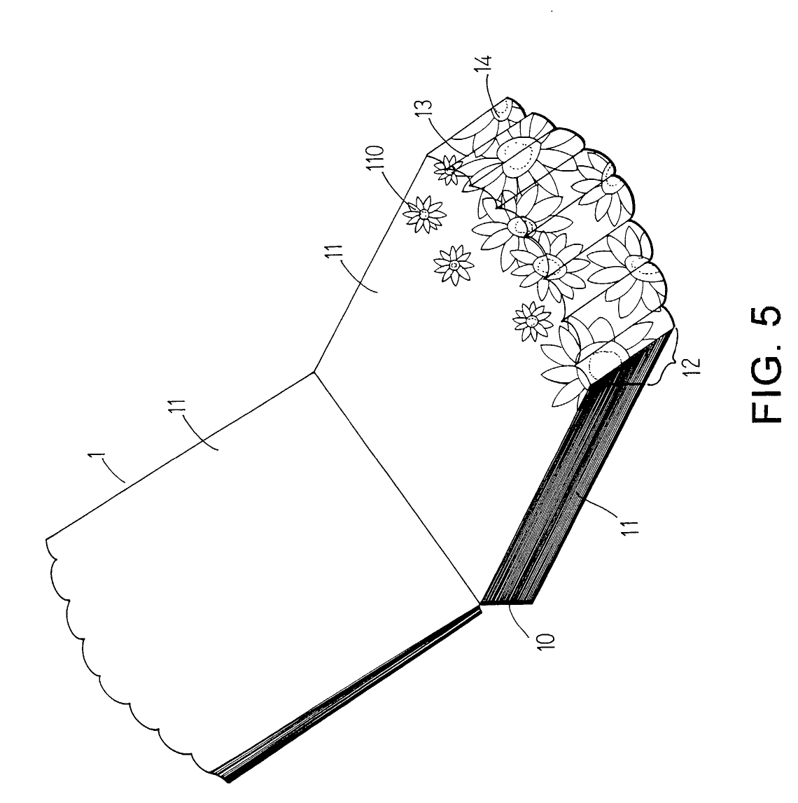

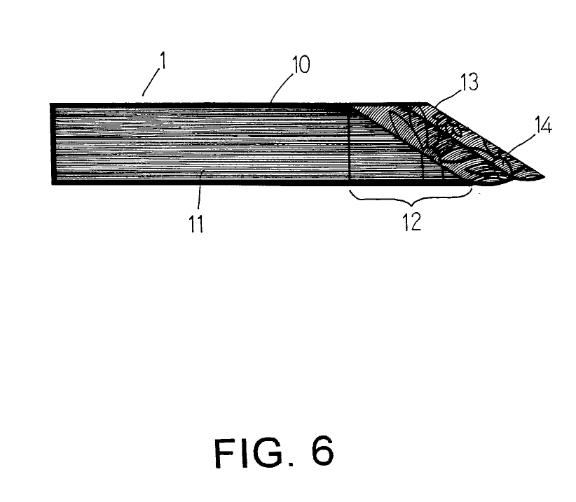

A preferred embodiment of memos 1 having a solid advertising effect 1 in the present invention, as shown in FIGS. 4-6, includes an upper and a lower cover 10 and a plurality of memos 11 packed together.

The upper cover 10 has its upper surface printed with advertising characters and colorful designs 100. The memos 11 are respectively printed with advertising characters or designs 110 the same as those on the upper cover, and packed to have front ends forming a sloped corrugated surface, which is printed with embossed advertising characters or designs 140. The rear ends of the covers 10 and those of the packed memos 11 are adhered together with glue, Thus, the solid corrugated sloped surface 13 is able to make the embossed advertising characters 14 thereon continuously combined with the designs 110 on the cover 10 vividly, letting the cover 10 and the memos 11 matched integrally to have an esthetic appearance and an effect of solid advertisement.

In addition, after some memos 11 are removed and used, the designs on the surface of the cover 10 and on the solid corrugated sloped surface 13 of the remaining memos 11 cannot completely disappear, able to always keep the advertising designs integrate.

To sum up, the invention has some advantages described below.

1. The memos 1 has one end cut into the solid corrugated sloped surface 13 by a special cutting technique to show effect of solid beauty of the advertising characters 14, increasing advertising effect and practicability.

2. The advertising characters 14 can always be kept integrate, regardless of the number of the memos 11, functioning as an effective means of advertisement to help expand business.

3. The designs printed on the memos 11 and on the upper cover 10 are of the coordinate colors to let the pack of the memos have integral beauty.

4. The pack of the memos has the front side cut to form the solid corrugated sloped surface 13, which is able to let the designs 110 on itself always match with the designs 100 on the cover 10 to make up its solid beauty.

While the preferred embodiment of the invention has been described above, it will be recognized and understood that various modifications may be made therein and the appended claims are intended to cover all such modifications that may fall within spirit and scope of the invention.

I claim

1. Memos having a solid advertising effect comprising an upper and a lower cover and a plurality of memos, said memos having rear ends glued with those of said covers, said upper cover and said memos respectively printed on with advertising characters or designs of coordinate colors, said upper cover and said memos having their front ends forming a sloped corrugated surface, said sloped corrugated surface printed with the same embossed advertising characters or designs as those of said cover: and,
said solid corrugated sloped surface able to make said designs on said cover continuously combined with said embossed advertising characters on said sloped corrugated surface, both said cover and said memos having solid advertising effect, regardless of continual gradual reduction of said memos owing to use, having integral beauty, extensive practicability and an excellent advertising effect.
